(19) United States
(12) Patent Application Publication
(10) Pub. No.: US 2004/0070217 A1
(43) Pub. Date: Apr. 15, 2004

(54) Door securing device

(76) Inventors: Durand K. Demlow, Lake Oswego, OR (US); John Michael O'Brien, Tualatin, OR (US)

Correspondence Address: Robert L. Harrington, Schwabe Williamson & Wyatt, Suites 1600-1900, 1211 SW Fifth Avenue, Portland, OR, 97204, US

(21) Appl. No.: 10/269,511

(22) Filed: Oct. 11, 2002

(51) Int. Cl. E05C 17/54

(52) U.S. Cl. 292/339

(57) ABSTRACT

A door securing device that can be secured and removed from a door easily and quickly and can be collapsed into a small unit for transport if desired. The door securing device comprises a base member, a brace member, and a projecting lip coupled to the door by way of an elastic member coupled to a door handle. The base member includes a projecting lip for engagement with the bottom of the door. A door handle hook being pivotally coupled to a telescoping shaft containing the elastic member therein, the hook being coupled to the door handle and the telescoping shaft extended under elastic bias such that the lip is positioned against the bottom of the door. The elastic bias securely holds the lip against the bottom of the door, and thus the door securing device to the door. The hook and shaft are pivotally coupled such that the shaft is positioned substantially parallel with the door. The door securing device remains on the door when in the locked or unlocked position. The brace member is pivotally mounted to the base member and is positional from an up position to allow free movement of the door and a down position to restrict movement of the door. In the down position, the brace member contacts the floor with a resilient foot that provides a gripping action to the brace member to prevent sliding on the floor. When the brace member is engaged with the floor, an opening force on the door will cause the brace member to pivot about the base member causing a force acting on the brace member about the foot which grips the floor and applies a force to the base member to cause forceful upward pressure on the bottom of the door. This upward pressure causes the door to be jammed against the door hinges and/or the doorframe preventing the opening of the door.

### FIELD OF THE INVENTION

This invention relates to portable door securing devices. More particularly, the present invention relates to door securing devices of the bracing type to secure a swinging door to prevent unauthorized opening of the door when the door securing device is in an operative position.

### BACKGROUND OF INVENTION

Security against break-ins has always been a major concern. For the traveler, the security of the hotel room door is of the utmost importance. For an apartment resident, there is commonly only the main exterior door and the resident might be unsure of the effectiveness of the door lockset and the deadbolt if there is one. The resident of a house has a similar problem with security but with far more doors to worry about. A significant portion of the strength of the deadbolt is determined by the structural integrity of the doorframe at the specific location of the deadbolt or latch. The doorframe may not sustain the impact of this concentrated force by the deadbolt being pushed through the doorframe.

Many prior art devices have been proposed to solve the problem of door security. Various wedge-type devices have been proposed that are jammed between the bottom of the door and the floor; easily dislodged by an outsider simply by shoving a magazine under the door dislodging the wedge.

Various bar-type devices that slip under the door knob and incline away from the door to the floor, a modern version of a “chair back” propped up against the door, have been proposed, but they are big, bulky, not easily storable when not in use, and rely on the strength of the door knob and the friction at the floor contacting point to resist the tend to get placed off to the side when not in use making it harder to locate and inconvenient when it is needed.

There is a need for an easy to use, portable, door securing device that is easy to install and remove from the door without marring the door in normal use, convenient to use, needs no storage as can remain on the door at all times, and yet extremely effective at preventing forceful entry.

### SUMMARY OF INVENTION

A door securing device that can be secured and removed from a door easily and quickly and can be collapsed into a small unit for transport if desired. The door securing device can be used with a home or a hotel room door or any other inwardly swinging door. The door securing device comprises a telescoping shaft having on one end a door handle hook and on the other end a base member with a brace member. The base member includes a projecting lip for engagement with the bottom of the door. The door handle hook is coupled to the door handle and the telescoping shaft is extended under spring bias such that the lip can be positioned against the bottom of the door. The spring bias securely holds the door securing device to the door. The hook and shaft are pivotally coupled such that the shaft is positioned substantially parallel with the door. The brace member is pivotally mounted to the base member and can be positioned in an up position to allow free movement of the door or in a down position in contact with the floor to restrict movement of the door. The brace member contacts the floor with a resilient foot that provides a gripping surface to the brace member to prevent sliding on the floor.

When the brace member is engaged with the floor, an opening force on the door will cause a pivotal force acting on the brace member about the foot which grips the floor and applies an oppositely applied force to the base member to cause forceful upward pressure on the bottom of the door by the lip. This upward pressure assures secure engagement of the lip and the bottom of the door and thus the base member to the door. Additionally, with sufficient opening force, this upward pressure causes the door to be jammed against the door hinges and/or doorframe providing, along with the bracing support of the brace member, structural support that resists further opening of the door.

The foot of the brace member is adapted to be used on any type of floor including a smooth floor and carpeting. The door securing device, in one embodiment, comprises an indicator light which provides a highly visible indication as to the engagement or disengagement of the door securing device.

### BRIEF DESCRIPTION OF DRAWINGS

FIG. 1 is a perspective view of a door securing device in accordance with an embodiment of the invention;

FIG. 2 is an exploded view of the door securing device in accordance with the embodiment of FIG. 1;

FIG. 3 is a cross-sectional view of a telescoping shaft in accordance with the embodiment of FIG. 1;

FIG. 4A is a back perspective view of the base member in accordance with the embodiment of FIG. 1;

FIG. 4B is an exploded view of the base member in accordance with another embodiment of the invention;

FIG. 5 is an assembled cross-sectional view of the foot member in accordance with the embodiment of FIG. 2;

FIG. 6A is a side view of the head member of the embodiment of FIG. 2;

FIGS. 6B-6H are views of various door knob styles in accordance with the method of using the door securing device in accordance with the embodiment of FIG. 1;

FIG. 7A is a side view of the door securing device engaged with the door and floor surface in accordance with the embodiment of FIG. 1;

FIG. 7B is a side view of the door securing device under a door-opening force in accordance with the embodiment of the invention of FIG. 1;

FIG. 8 is a perspective view of a door securing device in accordance with another embodiment of the invention;

FIG. 9 is a back perspective view of a base member in accordance with the embodiment of FIG. 8;

FIG. 10 is a front view of a door securing device in accordance with another embodiment the invention;

FIG. 11 is a side view of a door securing device in accordance with another embodiment the invention;

FIGS. 12A-12C are perspective, top and side views, respectively, of a door securing device in accordance with another embodiment of the invention;

FIGS. 13A and 13B are section views of an alternate form of the telescoping shaft; and

FIG. 14 is a view of yet a further embodiment of the invention.

### DESCRIPTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

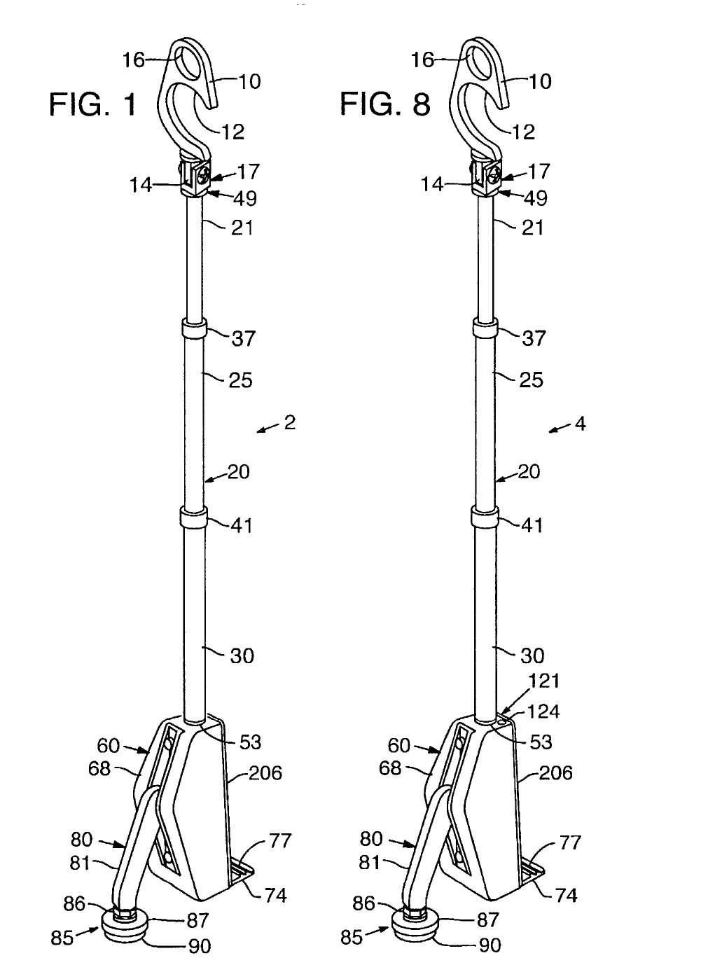

FIG. 1 is a perspective view of a door securing device 2 in accordance with an embodiment of the invention. The door securing device 2 is portable and easily attaches to a swing-out door by coupling with a door handle and a bottom edge of the door under spring tension when engaged with the door. When set in a securing position, the door securing device 2 prevents the door from being opened or swinging inwardly by bearing against the floor and the bottom of the door when under load. When disengaged, the door securing device 2 may remain attached to the door and does not impede door operation. Alternatively, the door securing device 2 is easily removed from the door when desired and retracts to a compact length.

The door securing device 2 comprises a head member 10, a telescoping shaft 20, a base member 60 and a brace member 80. The head member 10 has a generally C-shaped hook 12 adapted to accommodate a stem of a door handle therein. The head member 10 further comprises a shaft coupling member 14 details of which will be discussed below. The head member 10 further comprises a loop 16 that facilitates storing the door securing device 2 by hanging on a post or hook when not in use.

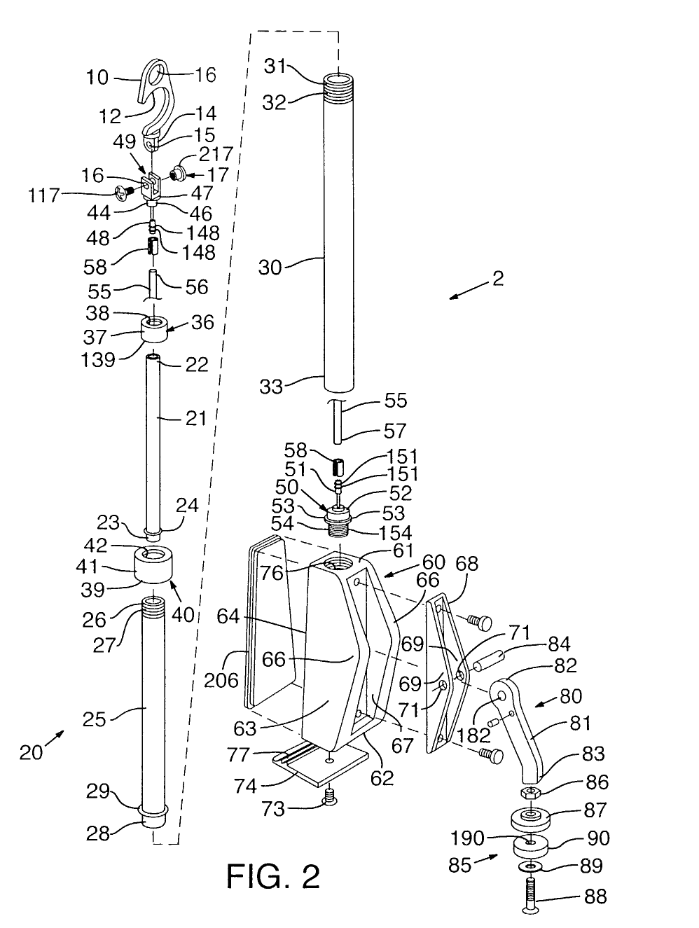

FIG. 2 is an exploded view of the door securing device 2 in accordance with the embodiment of the invention as shown in FIG. 1. The telescoping shaft 20 comprises an upper tube member 21, a center tube member 25 and a lower tube member 30. The upper tube member 21, center tube member 25 and lower tube member 30 are adapted to nest into each other; the center tube member 25 having an internal diameter sized to receive the upper tube member 21, and the lower tube member having an internal diameter sized to receive the center tube member 25. The telescoping shaft 20 is adapted to retract in length to substantially the length of the lower tube member 30 or expand in length to substantially the length of the sum of the lengths of the upper tube member 21, center tube member 25 and lower tube member 30.

The upper tube member 21 comprises an upper tube first end 22 and an upper tube second end 23. Proximal the upper tube second end 23 is an upper tube flange 24. The center tube member 25 comprises a center tube first end 26 and a center tube second end 28. Proximal the center tube second end 28 is a center tube flange 29. And the lower tube member 30 comprises a lower tube first end 31 and a lower tube second end 33.

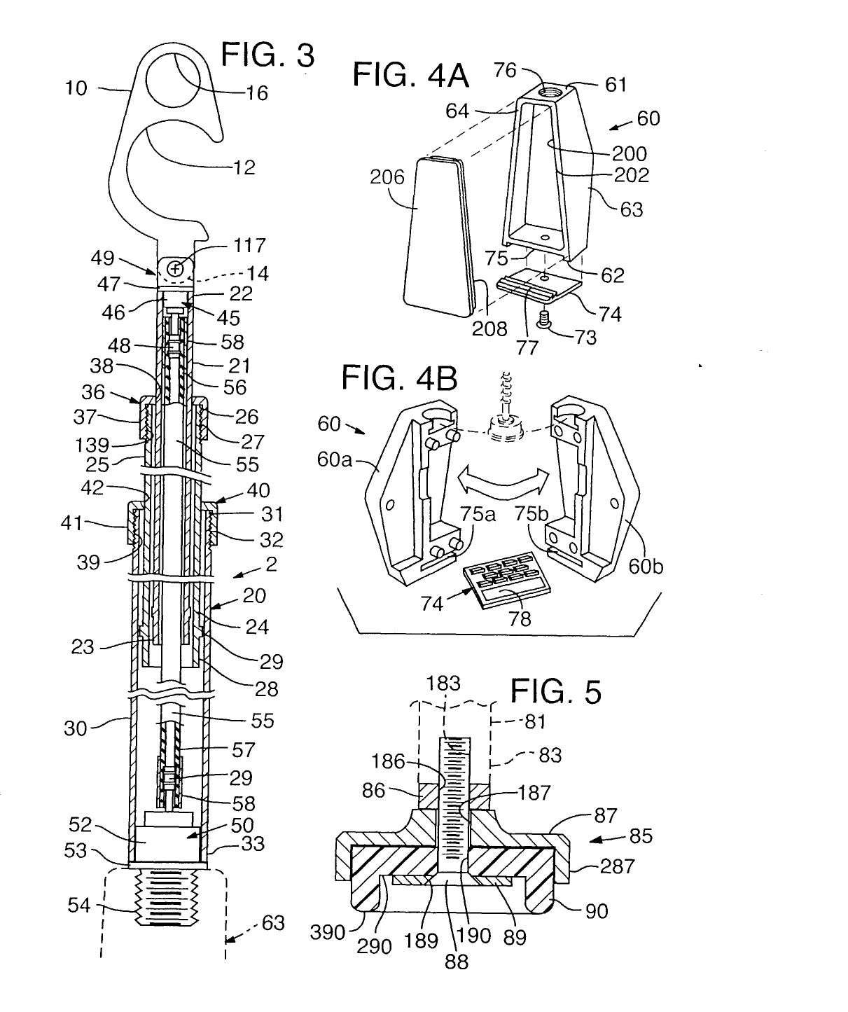

FIG. 3 is a cross-sectional view of the telescoping shaft 20 in accordance with the embodiment of the invention as shown in FIG. 1. The telescoping shaft 20 is assembled using an upper retaining collar 36 and a lower retaining collar 40. The lower retaining collar 40 is a tubular member having a lower tube receiving end 41 with an inner diameter adapted to receive the lower tube first end 31. The lower retaining collar 40 comprises a lower collar flange 42 having an inner diameter larger than the outer diameter of the center tube member 25 but smaller than the center tube flange 29. The lower tube receiving end 41 of the lower retaining collar 40 is adapted to receive and couple with the lower tube first end 31. During assembly, the center tube second end 28 is slidably received into the lower tube first end 31. The lower retaining collar 40 is received, lower tube receiving end 41 first, over the center tube first end 26 and advanced toward the lower tube first end 31 and coupled thereto. The center tube member 25 can slide within the lower tube member 30 but is prevented from disassembly by the cooperation between the center tube flange 29 and the lower collar flange 42.

In the embodiment shown in FIGS. 2 and 3, the lower tube first end 31 comprises external threads 32 and the lower tube receiving end 41 comprises internal threads 39 adapted to accept the external threads 32, as shown in FIG. 3. The lower tube receiving end 41 is threadably coupled to the lower tube first end 31.

In similar fashion, the upper tube member 21 is coupled to the center tube member 25 using the upper retaining collar 36. The upper retaining collar 36 is a tubular member having a center tube receiving end 37 with an inner diameter adapted to receive the center tube first end 26. The upper retaining collar 36 comprises an upper collar flange 38 having an inner diameter larger than the outer diameter of the upper tube member 21 but smaller than the upper tube flange 24. The center tube receiving end 37 of the upper retaining collar 36 is adapted to be received by and couple with the center tube first end 26. The upper tube second end 23 is slidably received into the center tube first end 26. The upper retaining collar 36 is received, center tube receiving end 37 first, over the upper tube first end 22 and advanced toward and coupled to the center tube first end 26. The upper tube member 21 can slide within the center tube member 25 but is prevented from disassembly by the cooperation between the upper tube flange 24 and the upper collar flange 38. The center tube first end 26 comprises external threads 27 and the center tube receiving end 37 comprises internal threads 139 adapted to accept the external threads 27. The center tube receiving end 37 is threadably coupled to the center tube first end 26.

The scope of the present invention is not limited to threaded engagement of the upper and lower retaining collars 36,40 to the center and lower tube members 25,30, respectively. In other embodiments, not shown, rather than with threads, the upper and lower collars 36,40 are coupled to the center and lower tube members 25,30, respectively, with adhesive, by welding, snug friction fit, or other means suitable for the particular purpose.

Referring again to FIGS. 2 and 3, the telescoping shaft 20 further comprises an upper tube cap 44 and a lower tube cap 50. The upper tube cap 44 comprises an upper tube receiving end 46 and a stop flange 47 proximal to the upper tube receiving end 46. The upper tube receiving end 46 is adapted to be inserted into the upper tube first end 22 with a snug slip-fit and in abutment with the stop flange 47. Projecting from the upper tube receiving end 46 is an upper elastic member coupling 48, which will be described below. The upper tube cap 44 further comprises a head coupling member 49 adapted to couple with the shaft coupling member 14 of the head member 10.

The lower tube cap 50 comprises a lower tube receiving end 52 and a stop flange 53 proximal to the lower tube receiving end 52. The lower tube receiving end 52 is adapted to be inserted into the lower tube second end 33 with a snug slip-fit and in abutment with the stop flange 53. Projecting from the lower tube receiving end 52 is a lower elastic member coupling 51, which will be described below. The lower tube cap 50 further comprises a base coupler end 54.

The scope of the present invention is not limited to a snug slip-fit engagement of the upper tube receiving end 46 and the upper tube first end 22, and the lower tube receiving end 52 and the lower tube second end 33, respectively. In other embodiments, not shown, rather than snug slip-fit engagement, the engagement can be made with threads, adhesive, by welding, and other means suitable for the particular purpose.

The telescoping shaft 20 further comprises an elastic member 55. The elastic member 55 is adapted to instill spring-bias to the telescoping shaft 20 to exert a contractile force as the upper tube member 21, center tube member 25 and lower tube member 30 are in an extended configuration. The elastic member 55 has a first end 56 and a second end 57. The first end 56 is adapted to couple with the upper elastic member coupling 48 and the second end is adapted to couple with the lower elastic member coupling 51. The length of the elastic member 55 is adapted to instill relatively little or no spring bias when the telescoping shaft 20 is in the collapsed state, but exerts a return force when in an extended state. A relatively little spring bias in the elastic member 55 when the telescoping shaft 20 is in the collapsed state will ensure that the door securing device 2 remains in a compact state when carried and stored.

In the embodiment shown in FIG. 2, the elastic member 55 is elastic tubing. The upper elastic member coupling 48 is adapted to snugly insert into the first end 56 of the elastic member 55 and resist pull-off. To augment pull-off resistance, the upper elastic member coupling 48 further comprises backward-facing barbs 148 adapted for easy insertion into the first end 56 but significant resistance to pull-off. In similar fashion, the lower elastic member coupling 51 having backward-facing barbs 151 is adapted to couple with the second end 57 of the elastic member 55. The tubing clamps 58 are optionally used to augment the pull-off resistance by exerting onto the first and second ends 56,57 a circumferential clamping force against the upper and lower elastic member couplings 48,51, respectively. The scope of the present invention is not limited to an elastic member 55 comprising elastic tubing. In other embodiments, not shown, the elastic member 55 is a spring, elastic band, or other elastic component suitable for the particular purpose.

The upper tube member 21, center tube member 25 and lower tube member 30 comprise a material to that can withstand repeated telescoping motion and handling. A suitable material such as aluminum is both durable and can be made aesthetically pleasing to the consumer. Anodized aluminum is particularly durable and aesthetically pleasing. A sufficiently durable plastic or steel material, among others, could also be used, as well as other materials suited for the particular purpose. The upper and lower retaining collars 36,40 comprise a similar material as the upper, center, and lower members 21,25,30.

FIG. 2 shows an exploded view of the base member 60 and brace member 80 in accordance with the embodiment of FIG. 1. The base member 60 comprises a top 61, a bottom 62, a front 63 and a back 64. The top 61 is adapted to couple with the base coupler end 54 of the telescoping shaft 20. In the embodiment shown, the top 61 comprises an internally threaded bore 76 adapted to accept the base coupler end 54 comprising threads 154. The scope of the present invention is not limited to a threaded bore 76 and base coupler end 54 comprising threads 154. In other embodiments in accordance with the present invention, not shown, the telescoping shaft 20 and the base member 60 are coupled using adhesives, welding and other fastening means suitable for the intended purpose.

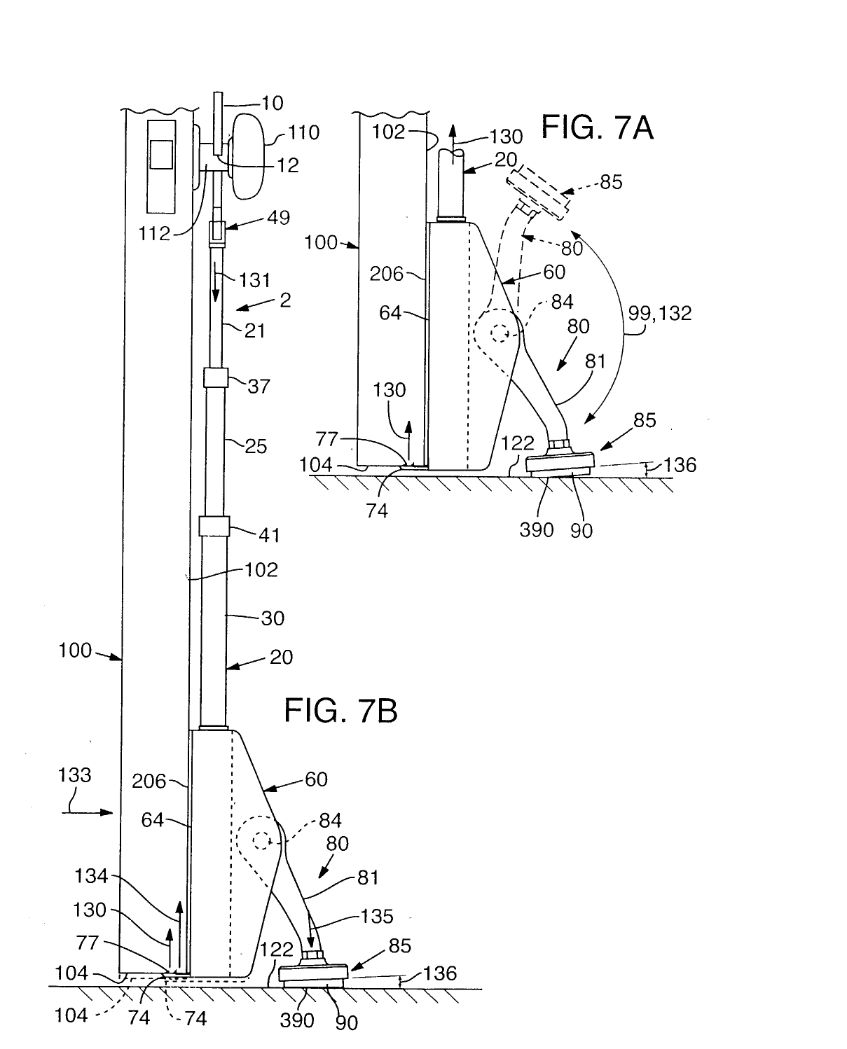

The base member 60 further comprises a lip 74 coupled to the bottom 62. The lip 74, as coupled to the base member 60, projects beyond the back 64 a designated distance, as shown clearly in FIGS. 1 and 7A. The lip 74 is adapted to contact a bottom surface of a door as the back 64 is placed in contact with an interior surface of the door, as will be discussed below. Additionally, and optionally, the back 64 comprises one or more resilient pads or buttons 206, that prevents the back 64 from marring the door and to provide additional frictional grip between the back 64 and the door interior surface. Additionally, and optionally, the lip 74 also has one or more resilient pads, not shown, to provide additional frictional grip with the bottom surface of the door. Additionally, and optionally, the lip 74 comprises a serrated surface 77 or other like roughness in the forms including, but not limited to, ridges, teeth, or bumps, to enable the lip 74 to effectively grip the bottom surface of the door.

It is anticipated that some doors have weather-stripping along the bottom of the door. Such weather-stripping is commonly attached in a few locations by fasteners leaving areas between fasteners into which a thin blade may pass between the weather-stripping and the door bottom. In one embodiment in accordance with the invention, the lip 74 is adapted to have a thickness and projection distance to pass between a portion of the weather-stripping and the bottom of the door.

FIG. 4A is a rear view of the base member 60 of the embodiment of FIG. 2. The bottom 62 comprises a slot 75 into which the lip 74 is partially received. The lip 74 is secured to the bottom 62 with a suitable fastener, such as a set screw 73. FIG. 4B is an exploded view of another embodiment of the base member 60 which is split into a left side 60a and a right side 60b each comprising a slot 75a and 75b, respectively, into which the lip 74 is retained when assembled. The lip 74 is coupled in the slots 75a,75b by the interaction between a mating surface 78 and the slots 75a,75b. In other embodiments, not shown, the lip 74 is integral with the bottom 62 of the base member 60 and formed as a unitary structure with the base member 60.

Referring again to FIG. 2, the back 64 is shown with an optional cavity 200 to conserve material and make the base member 60 lighter in weight.

The brace member 80 comprises an elongated leg 81 and a foot member 85. The leg 81 has a bent, dog-legged or arc shape, the significance of which will be discussed below. The leg 81 comprises a pivot end 82 and a foot end 83. The pivot end 82 is adapted to pivotally couple with the base member 60. The front 63 comprises two parallel base flanges 66 defining a base channel 67. A channel insert 68 comprising two parallel channel flanges 69 is inserted into the base channel 67 and coupled thereto. The two channel flanges 69 comprise coaxial flange apertures 71 adapted to accept a pivot pin 84. The pivot end 82 of the leg 81 comprises a leg aperture 182 adapted to accept the pivot pin 84. The pivot end 82 is coupled to the channel insert 68 by positioning the leg aperture 182 between and in coaxial alignment with the flange apertures 71 and inserting the pivot pin 84 there through. The leg 81 therefore, is able to pivot in an arc indicated by arrow 99 from a first position to a second position, as shown in FIG. 7A.

The foot member 85 is adapted to couple with the foot end 83 of the leg 81. The foot member comprises a footpad 90. The footpad 90 comprises a material having a low durometer to provide a good grip against a hard floor surface, which will be clearly understood with the description to follow. A material having a durometer value of between 40 and 70 Shore will provide acceptable gripping characteristics, but the values given are for illustrative purposes only and not intended to limit the scope of the invention. The shape of the footpad 90 and any friction-enhancing features will also contribute to the grip-strength of the footpad 90.

FIGS. 2 and 5 show exploded and assembled cross-sectional views, respectively, of the foot member 85 in accordance with the embodiment of FIG. 2. The foot member 85 further comprises an adjustable lock ring 86, a foot cup 87, a foot screw 88, and a washer 89. The footpad 90 is disk-shaped having a central footpad bore 190, a washer recess 290 coaxial with the footpad bore 190, and a bottom surface 390. The lock ring 86 comprises a threaded lock ring bore 186. The foot cup 87 has a cup end 287 adapted to accept a portion of the height of the footpad 90 therein while leaving a portion of the footpad 90 extending beyond the cup end 287. The washer 89 comprises a washer aperture 189 in coaxial alignment with the footpad bore 190. The foot end 83 of the leg 81, shown in FIG. 4, further comprises a threaded bore 183 adapted to accept the foot screw 88. The assembly of the foot member 85 comprises inserting the footpad 90 into the cup end 287 with the washer recess 290 facing away from the foot cup 87, and inserting the washer 89 into the washer recess 290. The cup end 287 provides support for the footpad 90. The foot screw 88 is inserted through the washer aperture 189, the footpad bore 190, the foot cup bore 187 and the threaded lock ring bore 186 and threadably coupled to the threaded bore 183 of the foot end 83. The washer 89 prevents damage to the footpad 90 from the foot screw 88 by distributing the fastening force of the foot screw 88 over a broad area of the footpad 90. The foot screw 88 is counter-sunk into the washer recess 290 and does not protrude beyond the bottom surface 390 in order to protect a surface upon which the bottom surface 390 contacts.

The distance between the footpad 90 and the foot end 83 is adjustable to account for various distances between the bottom of the door and the floor. The adjustment is provided by the adjustable lock ring 86. The adjustable lock ring 86 is advanced along the foot screw 88 a desired distance such that upon assembly of the foot member 85, the adjustable lock ring 86 abuts the foot end 83 such that the footpad 90 is at a desired distance from the foot end 83. The desired distance is one in which the footpad 90 rests at an angle 136, as shown in FIG. 7A, when in contact with the floor, as will be discussed below. Other desired distances resulting in the footpad 90 resting at larger or smaller angles 136 than shown, including flat to the floor, is also within the scope of the invention.

The angle 136 of the footpad 90 to the floor and/or the shape of the leg 81 determine the degree of pivoting or rocking of the leg 81 with respect to the base 60, and therefore the degree of lifting forces on the door, as will be discussed below.

Other foot member configurations, not shown, are within the scope of the invention, some of which include: a rubber plug or cap that inserts into or over, respectively, the foot end 83 of the leg 81; and a foot end 83 having a cup shape to accept the footpad 90, the footpad 90 being coupled to the leg 81 using adhesive, fasteners or other attachment means suitable for the intended purpose. The examples used here are for illustrative purposes only and not intended to limit the scope of the invention.

Referring again to FIG. 2, the detail of the assembly of the head member 10 and the head coupling member 49 is shown. The shaft coupling member 14 is adapted to couple with the head coupling member 49 of the upper tube cap 44. The shaft coupling member 14 and the head coupling member 49 each comprise apertures 15,16 which can be positioned coaxially and adapted to accept a fastener 17 there through. The embodiment of FIG. 2 shows the fastener 17 comprising a nut 217 and bolt 117, but the scope of the invention is not limited to such. In other embodiments in accordance with the present invention, not shown, other fastening methods include welding, riveting, and other fastening means suitable for the intended purpose.

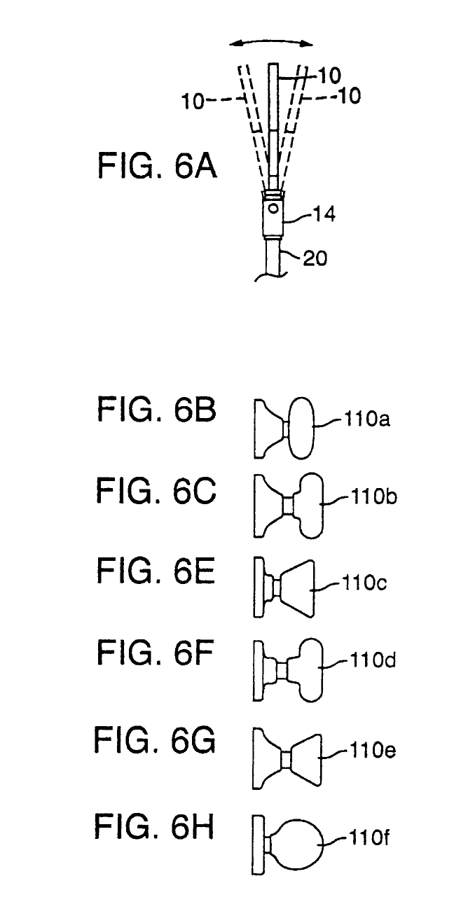

FIG. 6A is a side view of the head member 10 and the telescoping shaft 20 of the embodiment of FIG. 2. The head member 10 is allowed to frictionally pivot with respect to the telescoping shaft 20, the significance of which will be discussed below.

FIGS. 7A-B show a side view of the embodiment of FIG. 1 in accordance with the method of using the present invention. In use, the door securing device 2 is attached to a swinging door 100 having a door interior surface 102 and a door bottom surface 104. The door 100 further comprises a door handle 110 having a door handle stem 112. The head member 10 is attached to the door handle 110 by inserting the door handle stem 112 into the hook 12. The door securing device 2 is able to hang on the door handle stem 112. The telescoping shaft 20 is extended such that the lip 74 of the base member 60 can be tucked under and engage the door bottom surface 104 as the back 64 of the base member 60 abuts the door interior surface 102 adjacent the door bottom surface 104. The elastic member 55 asserts a return force indicated by arrow 130 on the lip 74 causing an urging engagement between the lip 74 and the door bottom surface 104, and a return force indicated by arrow 131 on the head member 10 which securely couples the door securing device 2 to the door 100 by spring bias.

Referring again to FIG. 6A the head member 10 is allowed to frictionally pivot with respect to the telescoping shaft 20 to ensure that the telescoping shaft 20 can be positioned in a substantially parallel relationship with the door 100 for various styles of door handles 110a-f, such as those shown in FIGS. 6B-6H, respectively. But for the frictional pivoting of the telescoping shaft 20 and the head member 10, the engagement of the head member 10 with the door handles 110a-f will tend to align the telescoping shaft 20 at an angle away from the door 100 potentially causing the lip 74 to slip out from engagement with the door bottom surface 104. A frictional pivoting engagement between the telescoping shaft 20 and the head member 10 is provided such that once the door securing device 2 is engaged with the door handle 110 and the door bottom surface 104, the telescoping shaft 20 and the head member 10 are frictionally pivoted such that the telescoping shaft 20 is retained in substantially parallel relationship with the door 100, and the back 64 of the base member 60 lies against the door interior surface 102 as shown

The brace member 80 can be moved to an up position, indicated in broken line, wherein the foot member 85 does not engage a floor surface 122. The brace member 80 can also be moved to a down position wherein the foot member 85 engages the floor surface 122. If security is not needed, the brace member 80 is positioned in an upright orientation held by a yielding means. In this position, the door securing device 2 does not obstruct the operation of the door 100. In an embodiment of the invention, the brace member 80 is retained in the upright position with frictional contact between the leg 81 and the channel flanges 69. Other methods of retaining the brace member 80 in the upright position include, but are not limited to, the use of a magnetic clasp, and a spring-loaded ball and detent clasp.

When the door 100 is to be secured, the brace member 80 is lowered such that the foot member 85, and more specifically the footpad 90, contacts the floor surface 122. The angle 136, as shown in FIG. 7A, in which the footpad 90 contacts the floor will be discussed below. The footpad 90 is a resilient material such as, but not limited to, rubber. The low durometer property of the footpad 90 is such as to create a friction/gripping engagement with the floor surface 122 preventing movement of the foot member 85 with respect to the floor surface 122.

FIG. 7B shows a side view of the base member 60, the brace member 80, and the door 100 as positioned while under an opening force indicated by arrow 133. With the brace member 80 in the floor-engagement position, an opening force on the door 100 in the direction indicated by arrow 133 will cause the brace member 80 to pivot with respect to the base member 60 about pivot pin 84 and, with sufficient force 133, a rocking motion about the foot member 85, reducing the angle 136 between the footpad 90 and the floor surface 122. The pivoting and/or rocking creates a downward force indicated by arrow 135 on the footpad 90, and a corresponding upward force indicated by arrow 134 on the lip 74 against the door bottom surface 104. The leg 81 having a bent, dog-leg or arc shape enhances the upward force 134 on the lip 74. The leg 81 having a straight shape will also cause an upward force 134 on the lip 74 and is within the scope of the invention.

With sufficient force on the door 100 in the direction indicated by arrow 133, the upward force 134 exerted by the lip 74 on the door bottom surface 104 will cause the door 100 to be lifted up. The original position of the door 100 is shown in dotted line. This upward lifting puts stress on the door hinges, which acts as additional support to resist door opening. If the opening force 134 is great enough, the door 100 will be lifted sufficient enough to contact the frame of the door 100, providing substantial support to resist an opening force.

The angle 136 of the bottom surface 390 of the footpad 90 to the floor surface 122 and the shape of the leg 81 determine the degree of pivoting of the leg 81 with respect to the base 60 and the degree of rocking of the foot member 85 with the floor surface 122, and therefore the degree of lifting of the door 100. One consideration in determining the desired angle 135 and the shape of the leg 81 is the construction of the door 100 and the door's 100 relationship to the hinges and doorframe. Under sufficient opening force 133, the door securing device 100 lifts the door 100 until the door 100 abuts and is stopped by the door hinges and/or doorframe. A door 100 that can be lifted a greater distance until it abuts the hinges and/or door frame will require a greater angle 136 and/or a greater curvature in the leg 81 to raise the door 100 until it abuts the hinges and/or frame, as compared to a door 100 that abuts the hinges and/or door frame with little lifting of the door 100.

FIG. 8 is a perspective view of a door securing device 4 in accordance with another embodiment of the invention. The door securing device 4 is substantially the same as the embodiment of FIG. 1, with the addition of a visible means 121 to confirm that the door securing device 4 is set to provide secure engagement of the door.

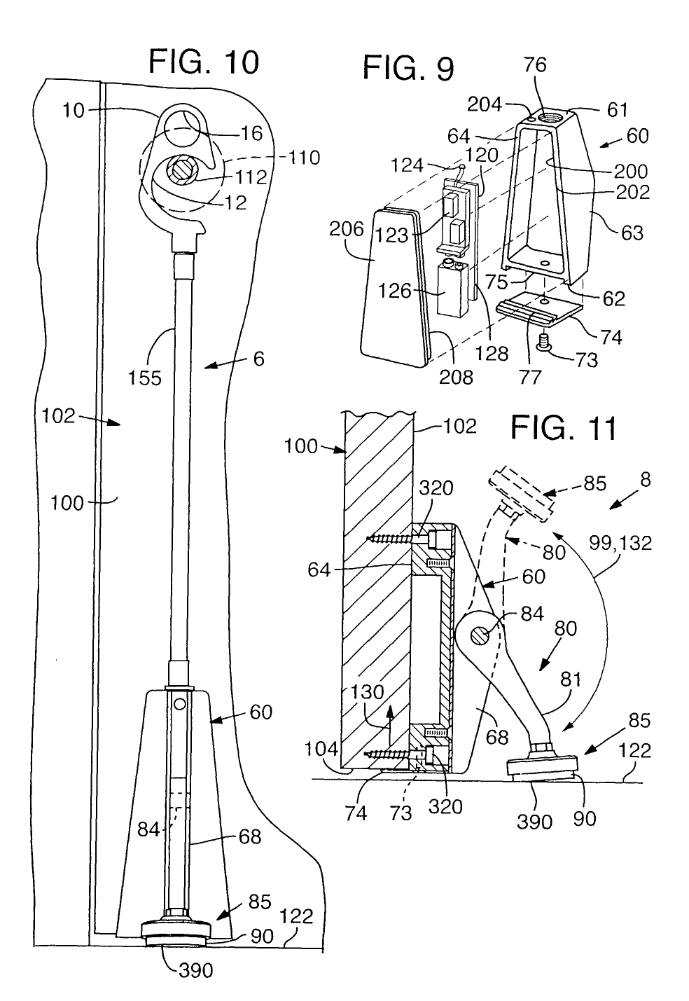

FIG. 9 is a perspective view of base member 60 in accordance with the embodiment of FIG. 8. The base member 60 further comprises a cavity 200 with a cavity opening 202 on the back 64 of the base member 60, a window 204, and an electronics package 120.

The electronics package 120 comprises a switch 123, a light emitting diode (LED) 124, and a power source 126, such as a battery. The electronics package 120 is adapted to be mounted within the cavity 200 of the base member 60 with the LED 124 placed adjacent the window 204. The switch 123 is adapted such that when the brace member 80 is in the up position, the LED 124 is not illuminated, and when the brace member 80 is in the down position, the LED 124 is illuminated indicating that the door securing device 4 is set to provide protection. In another embodiment, not shown, electronics are used in similar fashion to engage/disengage alarms or other securing devices.

The cavity cover 206 is adapted to cover and enclose the cavity 200. The cavity cover 206 comprises a ridge 208 which substantially conforms to the shape of the cavity opening 202. The cavity cover 206 is comprised of an elastomeric material that provides a snug press-fit around the cavity opening 202 as well as provides a friction-enhancing surface to the back 64 of the base member 60 while protecting the door surface from marring.

FIG. 10 is a front view of a door securing device 6 in accordance with another embodiment of the invention. The door securing device 6 comprises the head member 10, an elastic member 155, the base member 60 and the brace member 80. The door securing device 6 is substantially the same as the embodiment of FIG. 1, but without the tubing and retention collars associated with the telescoping shaft 20. The elastic member 155 is coupled to the head member 10 and the base member 60 using conventional methods. The door securing device 6 is used in substantially the same way as the embodiment of FIG. 1. In one embodiment of the invention, not shown, the head member 10 is replaced by a loop formed in the elastic member 155 adapted to be placed over the door handle 110.

FIG. 11 is a perspective view of a door securing device 8 in accordance with another embodiment of the invention. The door securing device 8 comprises the base member 60 and the brace member 80. The door securing device 8 is adapted for a permanent installation on the door 100 using conventional fastening means, for example, but not limited to, screws 320. The door securing device 8 affords the protection of the embodiments of FIGS. 1 and 10 but in a permanent installation. The head member 10 and telescoping shaft 20 and elastic member 155 are not needed in this embodiment to couple the base member 60 to the door 100.

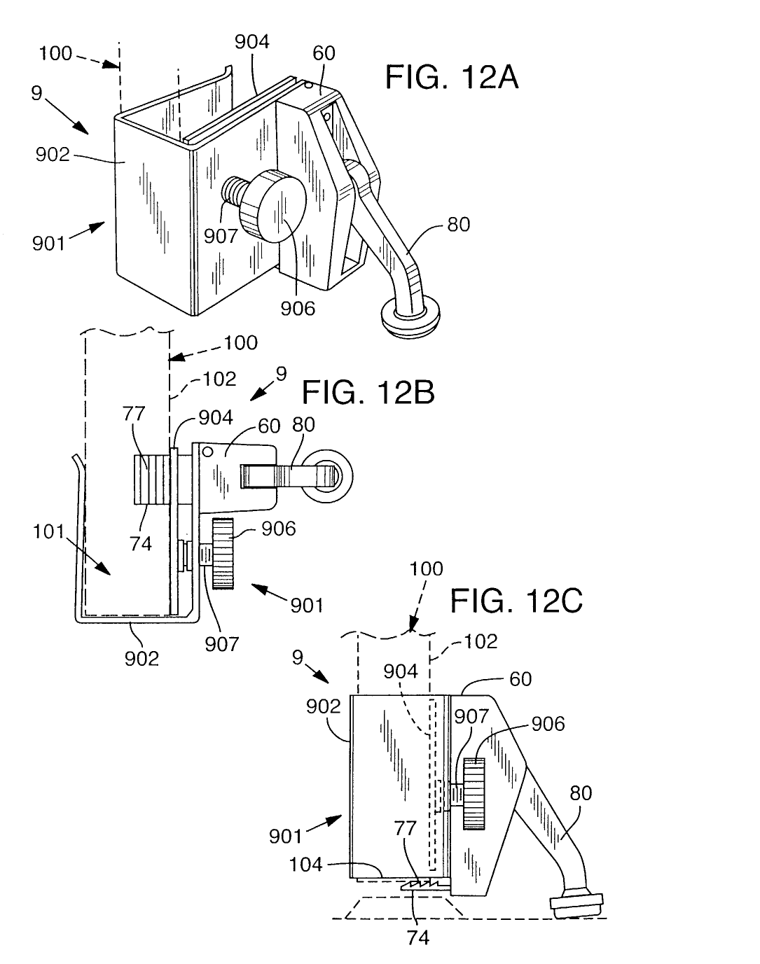

FIGS. 12A-12C are perspective, top and side views, respectively, of a door securing device 9 in accordance with another embodiment of the invention. The door securing device 9 is adapted to slide onto and be securely clamped to a bottom portion 101 of the door 100. The door securing device 9 comprises the base member 60, a brace member 80, and a clamp 901. The clamp 901 comprises a housing 902, a pressure plate 904, and a knob 906. The knob 906 comprises a threaded shaft 907 threadably received in the housing 902, the threaded shaft 907 being coupled to the pressure plate 904 contained within the housing 902. The housing 902 is generally C-shaped and adapted to accept the bottom portion 101 of the door 100 therein with the pressure plate 904 adjacent the door interior surface 102. The knob 906 is adapted to be turned to advance the pressure plate 904, the pressure plate 904 engaging the door interior surface 102 to effect a clamping pressure coupling the door securing device 9 to the door 100. The base member 60 is coupled to the housing 902 such that when the door securing device 9 is in clamping engagement with the door 100, the lip 74 is held adjacent the door bottom 10 surface 104. The door securing device 9 affords substantially the same securing protection of the embodiments of FIGS. 1, 10 and 11, but in an alternative temporary installation. The head member 10, telescoping shaft 20 and elastic member 155 are not needed in this embodiment to couple the base member 60 to the door 100.

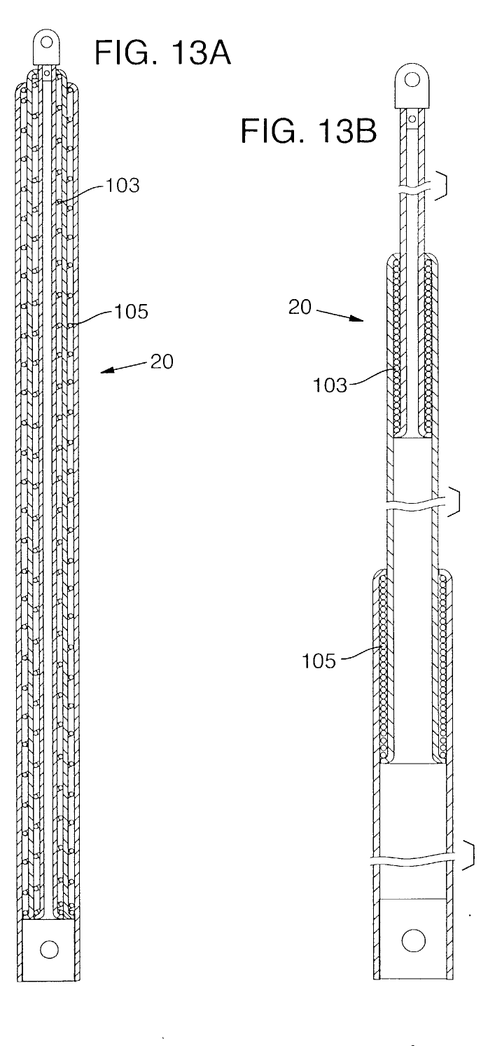

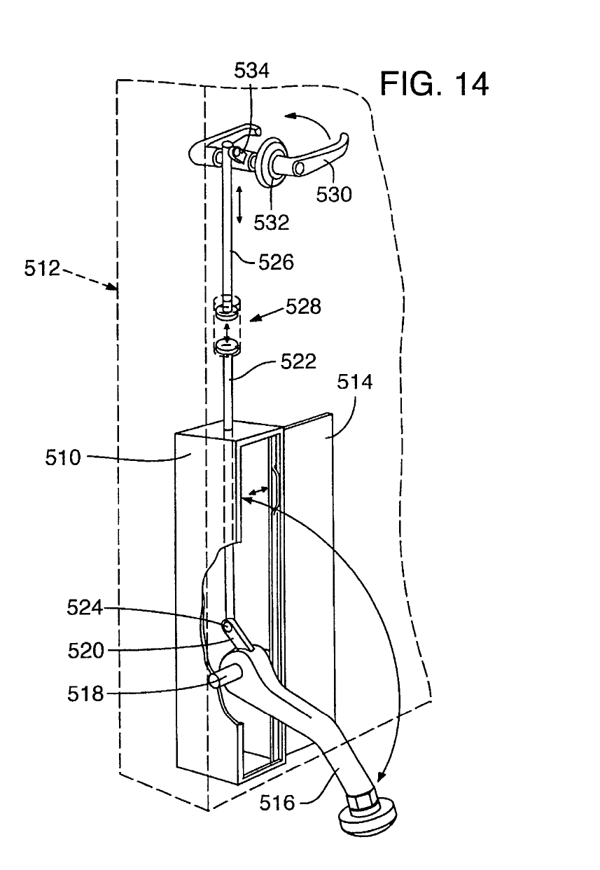

FIGS. 13A and 13B illustrate in cross section a further alternative to the telescoping shaft 20 of the securing device. As shown in FIG. 13A, compression-resisting springs 103, 105 urge the shaft 20 to its collapsed position and FIG. 13B illustrates the shaft 20 in the extended position, the springs 103, 105 being resistively compressed and providing added rigidity at the junctures of the tube members.

Any of the embodiments of the door securing device presented above can be used as a doorstop to prop open a swing door. The door securing device would be placed on the outward-facing side of an open door, in similar fashion as discussed. The use of the door securing device in this configuration would be especially useful as a portable doorstop for delivery personnel, among other users. The extra bracing effectiveness of the door securing device while used as a doorstop is especially effective at holding very heavy doors, or doors having very strong self-closing mechanisms, in the open position. Additionally, the door securing device used as a doorstop will greatly resist being bumped or kicked off the door during ingress or egress.

A yet further embodiment wherein the door securement device of this invention is set into the door, is illustrated in FIG. 14. As shown, a casing 510 is built into the door 512 but with the front of the casing being open to the inside surface of the door. A sliding cover 514 closes and opens the interior of the casing wherein a brace member 516 is pivotally mounted by pivot pin 518 to the side walls of the casing. An extension rod 520 is protruded from the brace member 516 and pivots down and up about pivot pin 518 as the brace member 516 is oppositely pivoted up and down.

It will be appreciated that when brace member 516 is fully pivoted upwardly, it will become seated inside the casing 510 and the sliding cover 514 can be closed to hide the door securement device when not in use. The cover 514 provides the additional advantage that the brace member 516 can not be inadvertently pivoted to the locked position.

As seen in FIG. 14, a lower rod 522 is connected by a swivel connection 524 to the brace extension 520. The lower rod 522 is protruded through the top of the casing as shown and connected to an upper rod 526. The connection between the lower and upper rod is indicated by reference 528 and allows limited movement as between the lower and upper rod, the purpose of which will be explained hereafter.

Door handle 530 is used to open and close a traditional door lock 532. The door lock 532 is modified to include a pivoting arm 534 which provides a connection at its distal end to the upper end of rod 526. Thus it will be understood that the pivotal movement of the door handle 530 and door lock 532 also raises and lowers the upper rod 526. The limited relative movement as between the upper and lower rods permits the normal pivoting of door handle 530 and thus opening and closing of the door.

When the door securing device of the invention is to be activated, the cover 514 is opened and the brace member is pivoted downward to engage the floor. The lower rod is pivoted upward without interference as permitted by the limited relative movement of the connection 528 between the lower and upper rods 522, 526. However, when the handle 530 is pivoted upward, and because the spacing between rods 522 and 526, i.e., at connection 528 has been eliminated, the upper rod 526 pushes down on rod 522 to reverse pivot the brace member 516 and unlock the door securing device. A person having a key to the door lock 532 will thus be able to enter the premises.

In its simplest form the securement device may consist of nothing more than the casing 510 fixedly installed in the door and the brace member 516 pivotally mounted to the casing. This is similar to the version of FIG. 11. The FIG. 14 version, however, lends itself to provision of the optional feature of door lock control as illustrated and described above.

Although specific embodiments have been illustrated and described herein for purposes of description of the preferred embodiment, it will be appreciated by those of ordinary skill in the art that a wide variety of alternate and/or equivalent implementations designed to achieve the same purposes may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly

What is claimed is:

1. A door securing device that resists the opening of an inwardly-swinging door, the door having an inner surface, an outer surface, a bottom surface, and a door handle having a stem, the stem coupled to the inner surface, the door being disposed above the floor, the door securing device comprising:
a head member having an engagement hook adapted to hang from the stem of the door handle;
a telescoping shaft being extendable and contractible in length, the shaft having a spring-bias that provides a restoring force when the telescoping shaft is in an extended position, the shaft having a shaft first end and a shaft second end, the head member coupled to the shaft first end;
a base member having a top, a bottom, a front and a back, the shaft second end coupled to the top, the bottom having a lip extending rearward a designated distance and in abutment with the door bottom directly below the door handle and the back in abutment with the door inner surface, the base member coupled to the door by the spring bias acting on the head member and the base member; and
a brace member comprising an elongated leg having a pivot end and a foot end, the pivot end pivotally coupled with the front of the base member, and the foot end adapted for gripping engagement with the floor, the leg pivotally positional between an up position wherein the foot end does not engage the floor and a down position wherein the foot end engages the floor.

2. The door securing device of claim 1 wherein the front of the base member comprises two parallel flanges defining a vertical channel, each flange having a flange aperture in coaxial relationship to each other, the brace member further comprising a pivot pin and a foot, the pivot end having a leg aperture, the pivot end coupled within the channel with the pivot pin inserted through the two flange apertures and leg aperture, the foot comprising a low durometer-value material and coupled to the foot end, the foot adapted to be apply gripping engagement with the floor.

3. The door securing device of claim 1 wherein the head member is pivotally coupled with the shaft first end, the head member and shaft first end pivot to position the telescoping shaft in substantially parallel relationship with the door inner surface.

4. The door securing device of claim 1 wherein the base member further comprises an electronics cavity and electronics components, the cavity being accessible from the back, the electronics components comprising a switch, a light emitting diode and a power source, the light from the diode being visible exterior to the base, the switch adapted to turn on the diode when the leg is in a floor engagement position and turn off the diode when the leg is not in a floor engagement position.

5. The door securing device of claim 3 wherein the lip comprises a lip top surface having a roughened surface to enhance the engagement of the lip and the door bottom surface.

6. The door securing device of claim 1, the telescoping shaft comprising:
an upper tube member comprising an upper tube first end, an upper tube second end, and an upper tube flange proximal the upper tube second end;
a center tube member comprising a center tube first end, a center tube second end, and a center tube flange proximal the center tube second end;
a lower tube member comprising a lower tube first end and a lower tube second end, the upper tube member slidably received within the center tube member, the center tube member slidably received within the lower tube member;
a lower retaining collar comprising a tubular member having a first end and a second end, the first end comprising a lower tube receiving end coupled to the lower tube first end received therein, the second end having an inner flange having an inner diameter larger than the outer diameter of the center tube member but smaller than the center tube flange, the lower tube received in and couple with the lower tube first end;
an upper retaining collar comprising a tubular member having a first end and a second end, the first end comprising a center tube receiving end coupled to the center tube first end received therein, the second end having an inner flange having an inner diameter larger than the outer diameter of the upper tube member but smaller than the upper tube flange, the center tube receiving end received and coupled with the center tube first end;
an upper tubing cap comprising an upper tube receiving end and a stop flange proximal to the upper tube receiving end, the upper tube receiving end received within the upper tube first end and coupled therewith and in abutment with the stop flange, the upper tube receiving end comprising an upper elastic member coupling projecting from the upper tube receiving end, the upper tubing cap further comprises a head coupling end pivotally coupled with the head member;
a lower tubing cap comprising a lower tube receiving end and a stop flange proximal to the lower tube receiving end, the lower tube second end received within the lower tube receiving end and coupled therewith and in abutment with the stop flange, the lower tube receiving end comprising a lower elastic member coupling projecting from the lower tube receiving end, the lower tubing cap further comprises a base coupler end coupled with the top of the base member; and
an elastic member comprising a first end and a second end, the first end coupled with the upper elastic member coupling and the second end coupled with the lower elastic member coupling, the elastic member having a length to instill little or no spring bias when the telescoping shaft is in the collapsed state, but exerts a return force when in an extended state.

7. The door securing device of claim 6 wherein the elastic member comprises elastic tubing having an inner diameter, the respective ends of the elastic tubing received on and coupled to the upper elastic member coupling and the lower elastic member coupling.

8. The door securing device of claim 7 wherein the upper and lower elastic receiving members each further comprise at least one rearward-facing barb that resists subsequent pull-off of the respective ends of the tubing.

9. The door securing device of claim 7 wherein the shaft further comprises tubing clamps, the clamps couple the respective ends of the tubing to the upper and lower elastic member coupling.

10. The door securing device of claim 5, wherein the roughened surface comprises one or more teeth to enhance the engagement of the lip and the door bottom surface.

11. A door securing device that resists the opening of a swing-in door, the door having an inner surface, an outer surface, a bottom surface, a hinged edge, and an outer edge opposite the hinged edge, the door being disposed above the floor, the door securing device comprising:
a channel structure having a first and second side in parallel relationship and a third side between and perpendicular to the first and second sides defining a channel, the channel slideably received on a portion of the door proximal the door bottom surface wherein the first and second parallel sides and perpendicular side are adjacent the inner and outer surfaces and outer edge, respectively, the first parallel side further comprising a threaded aperture;
a screw clamp having a threaded shaft, a knob and a push plate, the threaded shaft threadably advanced in the threaded aperture, the threaded shaft having a first end and a second end, the first end coupled to the knob and the second end coupled to the push plate, the push plate positioned between the door inner surface and the first parallel side, the clamp adapted to advance the pressure plate against the door inner surface as the knob is turned to removably secure the channel structure to the door;
a base member having a bottom, a front and a back, the back coupled to the first parallel side, the bottom having a lip extending rearward a designated distance and in abutment with the door bottom; and
a brace member comprising an elongated leg having a pivot end and a foot end, the pivot end pivotally coupled with the base member, the foot end adapted for gripping engagement with the floor, the leg pivotally positional between an up position wherein the foot end does not engage the floor and a down position wherein the foot end engages the floor.

12. The door securing device of claim 11 wherein the front of the base member comprises two parallel flanges defining a vertical channel, each flange having a flange aperture in coaxial relationship to each other, the brace member further comprising a pivot pin and a foot, the pivot end having a leg aperture, the pivot pin engaging the two flange apertures and leg aperture coupling the pivot end within the channel, the foot comprising a low durometer-value material, the foot coupled to the foot end, the foot adapted to apply gripping engagement with the floor.

13. The door securing device of claim 11 wherein the base member further comprises an electronics cavity and electronics components, the electronics components comprising a switch, a light emitting diode and a power source, the light from the diode being visible exterior to the base, the switch adapted to turn on the diode when the leg is in a floor engagement position and turn off the diode when the leg is not in a floor engagement position.

14. A door securing device that resists the opening of an inwardly-swinging door, the door having an inner surface, an outer surface, and a bottom surface, the door being disposed above the floor, the door securing device comprising:
a base member having a bottom, a front and a back, the base member coupled to the door with the back adjacent the inner surface, the bottom having a lip extending rearward a designated distance and in abutment with the door bottom; and
a brace member comprising an elongated leg having a pivot end and a foot end, the pivot end pivotally coupled with the base member and the foot end adapted for gripping engagement with the floor, the leg pivotally positional between an up position wherein the foot end does not engage the floor and a down position wherein the foot end engages the floor.

15. The door securing device of claim 14 wherein the front of the base member comprises two parallel flanges defining a vertical channel, each flange having a flange aperture in coaxial relationship to each other, the brace member further comprising a pivot pin and a foot, the pivot end having a leg aperture, the pivot pin engaging the two flange apertures and leg aperture coupling the pivot end within the channel, the foot comprising a low durometer-value material, the foot coupled to the foot end, the foot adapted to apply gripping engagement with the floor.

16. The door securing device of claim 14 wherein the base member further comprises an electronics cavity and electronics components, the electronics components comprising a switch, a light emitting diode and a power source, the light from the diode being visible exterior to the base, the switch adapted to close and illuminate the diode when the leg is in a floor engagement position as well as open and not illuminate the diode when the leg is not in a floor engagement position.

17. The door securing device of claim 17 wherein said resisting force is provided by compression-resisting springs.

18. A securement device comprising:
a door defining a door opening in a door frame consisting of side and top segments and said door having opposing side edges and opposing bottom and top edges, said door mounted for pivotal opening at one side edge to a side segment of said frame and with said bottom edge of the door slidably moving along and in close proximity to a floor underlying the door;
a bracket secured to the door adjacent the bottom edge and proximal to the opposite side edge;
an elongate brace member pivotally mounted to the bracket at one end and having a foot portion at the other end, said brace member pivotal in a vertical plane between a raised position adjacent the door and a lowered position with the foot portion engaging the floor, said elongate brace member and foot portion angularly configured when in the lowered position whereby the foot portion engages the floor and pivotal movement of the door toward the foot portion results in lifting of the door and binding of the door within said door frame to prevent opening of the door.

19. A securement device as defined in claim 18 which further comprises:
a door handle and a door lock mounted at a mid-height position on the door;
a brace member extension extended from the said one end of the brace member in a direction opposite the foot portion whereby up and down pivoting of the brace member produces reverse up and down pivoting of the extension; and
a rod extended from a distal end of the extension to the door lock and connected to the door lock whereby turning of the door handle produces up and down movement of the rod and accordingly raising and lowering of the brace member.

20. A securement device as defined in claim 19 wherein said rod includes a lower rod portion and an upper rod portion, said lower and upper rod portions connected so as to accommodate limited movement of the upper rod portion relative to the lower rod portion to permit limited turning of the handle without pivotal movement of the brace member.
